(19) United States
(12) Patent Application Publication
(10) Pub. No.: US 2025/0332903 A1
(43) Pub. Date: Oct. 30, 2025

(54) POWER STORAGE DEVICE

(71) Applicant: TOYOTA JIDOSHA KABUSHIKI KAISHA, Toyota-shi (JP)

(72) Inventors: Shingo AIJIMA, Sunto-gun (JP); Shigeyuki Inoue, Toyota-shi (JP)

(73) Assignee: TOYOTA JIDOSHA KABUSHIKI KAISHA, Toyota-shi (JP)

(21) Appl. No.: 19/089,109

(22) Filed: Mar. 25, 2025

(30) Foreign Application Priority Data
Apr. 26, 2024 (JP) 2024-072473

(51) Int. Cl. B60K 1/04; B60L 50/60; B62D 25/20; H01M 50/204; H01M 50/249; H01M 50/271

(52) U.S. Cl. CPC B60K 1/04; B60L 50/66; B62D 25/20; H01M 50/204; H01M 50/249; H01M 50/271; B60K 2001/0438; H01M 2220/20

(57) ABSTRACT

The power storage device is mounted on a vehicle. The vehicle includes a support member, and the power storage device includes a stack formed by stacking power storage modules in the up-down direction, and a housing case that houses the stack. The housing case includes a plate member that is formed so as to cover the upper surface of the stack and is located below the support member and on the upper surface of the housing case. The stack is bonded to the plate member in a region of the plate member excluding a region corresponding to the support member in the up-down direction.

### CROSS-REFERENCE TO RELATED APPLICATION

This application claims priority to Japanese Patent Application No. 2024-072473 filed on Apr. 26, 2024, incorporated herein by reference in its entirety.

### BACKGROUND

### 1. Technical Field

The present disclosure relates to a power storage device.

### 2. Description of Related Art

Japanese Unexamined Patent Application Publication No. 2021-123227 (JP 2021-123227 A), for example, discloses a power storage device that is installed in a lower portion of a vehicle. The power storage device includes a housing case and a stack that is housed in the housing case. The stack and the housing case are bonded to each other in an up-down direction.

### SUMMARY

The housing case of the power storage device described in JP 2021-123227 A is restrained by a vehicle body structure from upward and downward directions. Accordingly, when the stack that is made up of power storage modules stacked in the up-down direction expands in the up-down direction, the power storage device is subjected to a load in the up-down direction from the vehicle body structure.

The present disclosure has been made in order to solve the above-described problems, and an object thereof is to provide a power storage device that is capable of suppressing a load in an up-down direction that a power storage device is subjected to by expansion of a stack in the up-down direction.

A power storage device according to a first aspect of the present disclosure is a power storage device that is installed in a vehicle, in which
the vehicle includes a support member,
the power storage device includes a stack that is made by stacking power storage modules in an up-down direction, and a housing case that houses the stack,
the housing case is fashioned so as to cover an upper face of the stack, and also includes a plate member that is situated on an upper face of the housing case, downward from the support member, and
the stack is bonded to the plate member in a region of the plate member excluding a region corresponding to the support member in the up-down direction.

In the vehicle in which the power storage device according to the first aspect of the present disclosure is installed, a vehicle cabin space is fashioned in which a passenger rides, and
the vehicle cabin space and a vehicle outer space are partitioned by the plate member.

The vehicle in which the power storage device according to the first aspect of the present disclosure is installed further includes a floor member, in which
the floor member is situated downward from the support member,
the housing case further includes an upper cover and a lower case, and
the upper cover includes the plate member.

In the vehicle in which the power storage device according to the first aspect of the present disclosure is installed, the floor member and the plate member are arrayed in the up-down direction with a spacing between.

In the vehicle in which the power storage device according to the first aspect of the present disclosure is installed, the support member, the floor member, and the plate member are fixed in the up-down direction by a linking member, and
a spacing in the up-down direction between the plate member and the stack is greater than the spacing in the up-down direction between the floor member and the plate member.

According to the power storage device of the present disclosure, the load in the up-down direction that the power storage device is subjected to, by expansion of the stack in the up-down direction, can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view illustrating a schematic configuration of a power storage device according to the present embodiment;

FIG. 2 is a cross-sectional view of II-II section shown in FIG. 1; and

FIG. 3 is a cross-sectional view of a vehicle body and a power storage device according to a modification of the present embodiment.

### DETAILED DESCRIPTION OF EMBODIMENTS

Hereinafter, embodiments of the present disclosure will be described in detail with reference to the drawings. In the drawings, the same or corresponding parts are denoted by the same reference numerals, and the description thereof will not be repeated.

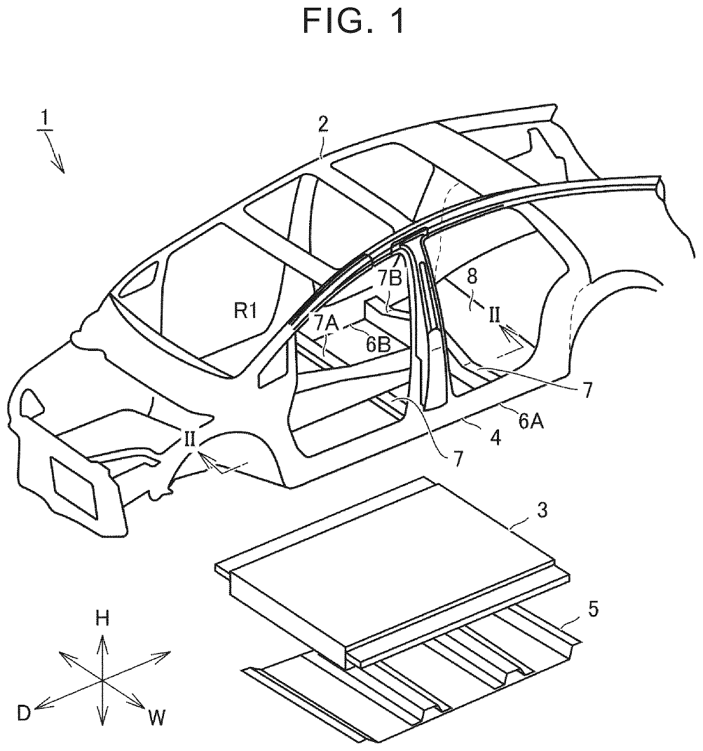

FIG. 1 is an exploded perspective view schematically showing a vehicle equipped with a power storage device according to the present embodiment. Note that the up-down direction H illustrated in FIG. 1 indicates the up-down direction of the vehicle 1. The width direction W indicates the vehicle width direction of the vehicle 1. The front-rear direction D indicates the front-rear direction of the vehicle 1.

The vehicle 1 includes a vehicle body 2 and a power storage device 3. The vehicles 1 include, for example, Plug-in Hybrid Electric Vehicle (PHEV), Battery Electric Vehicle (BEV), or Fuel Cell Electric Vehicle (FCEV). In the vehicle 1, a vehicle cabin space R1 is formed by the vehicle body 2. The vehicle cabin space R1 is a space in which a passenger rides in the vehicle 1.

The vehicle body 2 includes an under body 4 and a share panel 5. The underbody 4 includes a pair of side-shell 6A, 6B, a seat cross 7, and a floor panel 8. The seat cross 7 is an example of a “support member” of the present disclosure. The floor panel 8 is an example of a “floor member” of the present disclosure.

The pair of side-shell 6A, 6B are formed so as to extend in the front-rear direction D. The side-shell 6A, 6B are arranged at intervals in the widthwise direction W. Each of the side-shell 6A, 6B is disposed at one end and the other end of the vehicle body 2 in the widthwise direction W.

The seat cross 7 has a seat cross 7A and a seat cross 7B. The seat cross 7A, 7B is formed so as to extend in the widthwise direction W. The seat cross 7A, 7B are arranged so as to be arranged in the front-rear direction D. One end of each of the seat cross 7A, 7B in the widthwise direction W reaches the side shell 6A, and the other end thereof reaches the side shell 6B. The seat cross 7A is located in front of the vehicle with respect to the seat cross 7B in the front-rear direction D.

The floor panel 8 is a member arranged at the bottom of the vehicle body 2 and formed in a plate shape. One end and the other end of the outer peripheral end portion of the floor panel 8, which are arranged in the widthwise direction W, reach the side shell 6A and the side shell 6B, respectively. The floor panel 8 is provided at the bottom of the seat cross 7. That is, the floor panel 8 is located below the seat cross 7. The floor panel 8 partitions the vehicle cabin space R1 and the vehicle outer space.

The share panel 5 is disposed at a position facing the underbody 4 with the power storage device 3 interposed therebetween in the up-down direction H. The share panel 5 is fixed to the underbody 4.

The power storage device 3 is, for example, a device for storing power for driving the vehicle 1. The power storage device 3 is mounted on the vehicle 1. Specifically, the power storage device 3 is fixed to the vehicle body 2 by being fastened to each of the pair of side-shell 6A, 6B and the seat cross 7.

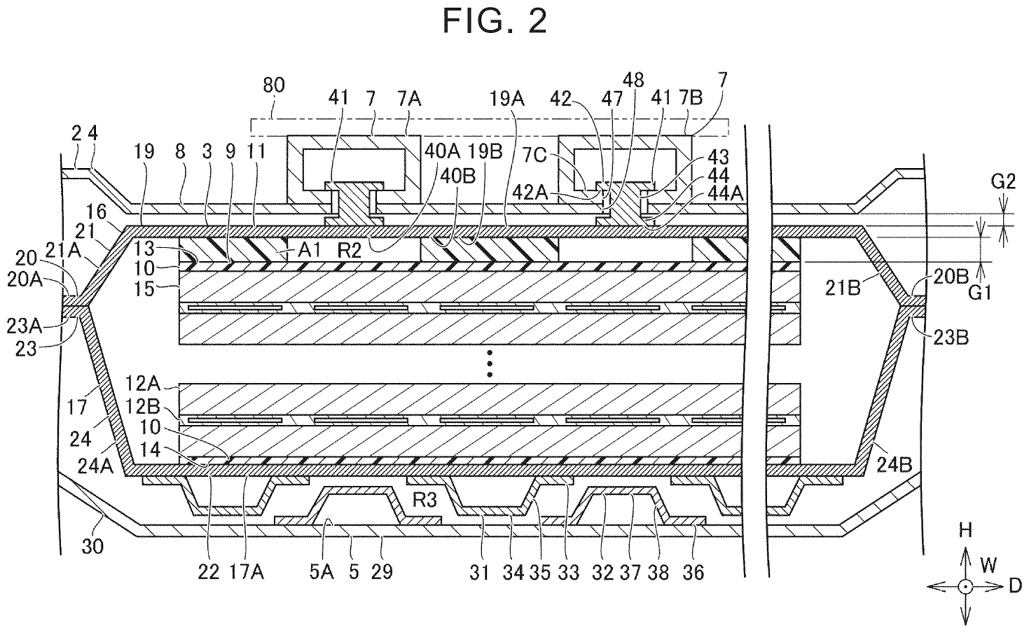

FIG. 2 is a cross-sectional view of II-II shown in FIG. 1. The power storage device 3 includes a stack 9 and a housing case 11. The power storage device 3 is disposed below the floor panel 8.

The stack 9 is formed in a rectangular parallelepiped shape, for example. The stack 9 has an upper surface 13, a lower surface 14, and a peripheral surface 15. The upper surface 13 and the lower surface 14 are surfaces arranged in the up-down direction H. The upper surface 13 is a surface located in the vicinity of the underbody 4 with respect to the lower surface 14. The peripheral surface 15 is a surface connecting the outer peripheral edge portion of the upper surface 13 and the outer peripheral edge portion of the lower surface 14.

The stack 9 includes a power storage module 12A, a cooling device 12B, and an insulating sheet 10.

The power storage module 12A is, for example, a bipolar battery. The power storage module 12A is formed in a rectangular shape in a plan view of the power storage module 12A from a position separated from the power storage module 12A in the up-down direction H. The power storage modules 12A are stacked in the up-down direction H with the cooling device 12B interposed therebetween.

The cooling device 12B is electrically conductive. Therefore, the cooling device 12B electrically connects the cooling device 12B and the power storage modules 12A that are adjacent in the up-down direction H to each other.

The insulating sheet 10 is formed of an insulating material. The insulating sheet 10 is provided at one end and the other end of the power storage module 12A stacked in the up-down direction H in the up-down direction H.

The housing case 11 includes an upper cover 16 and a lower case 17. The housing case 11 houses the stack 9.

The upper cover 16 is formed of a top plate 19, an upper flange 20, and a hanging wall 21. The top plate 19 is an example of a “plate member” of the present disclosure.

The top plate 19 is located on the upper surface of the case of the housing case 11. The top plate 19 is formed so as to cover the upper surface 13 of the stack 9. The top plate 19 and the stack 9 are arranged at a gap G1 in the up-down direction H. The top plate 19 is a plate-shaped member. The top plate 19 is formed in a rectangular shape in a plan view of the top plate 19 from a position separated from the top plate 19 in the up-down direction H. The top plate 19 and the floor panel 8 are arranged at a gap G2 in the up-down direction H. The top plate 19 is located below the floor panel 8. The gap G1 between the top plate 19 and the stack 9 in the up-down direction H is wider than the gap G2 between the top plate 19 and the floor panel 8 in the up-down direction H.

The upper surface 13 of the stack 9 is adhered to a part of the lower surface 19B of the top plate 19 by an adhesive A1. Specifically, the adhesive A1 is applied to the area 40B of the lower surface 19B of the top plate 19 except for the area 40A corresponding to the seat cross 7A, 7B in the up-down direction H. The space R2 is defined by the adhesive A1 applied to the area 40B, the top plate 19, and the stack 9.

The seat cross 7, the floor panel 8, and the top plate 19 are fixed by fastening members 41 in the up-down direction H.

More specifically, the fastening member 41 is formed of an upper member 42, a shaft member 43, and a lower member 44. The upper member 42, the shaft member 43, and the lower member 44 are formed in a cylindrical shape so as to extend in the up-down direction. The shaft member 43 connects the upper member 42 and the lower member 44. The upper member 42, the shaft member 43, and the lower member 44 are arranged coaxially in the up-down direction H. The seat cross 7 and the floor panel 8 have through holes 47 and 48, respectively. The through holes 47 and 48 are formed coaxially in the up-down direction H. The diameters of the through holes 47 and 48 are smaller than the diameters of the upper member 42 and the lower member 44, and larger than the diameter of the shaft member 43. The shaft member 43 is inserted into the through holes 47 and 48. The lower surface 42A of the upper member 42 is joined to the seat cross 7 in an area in contact with the inner peripheral surface 7C of the seat cross 7 in the up-down direction H. The lower surface 44A of the lower member 44 is joined to the top plate 19 in an area in contact with the upper surface 19A of the top plate 19 in the up-down direction H.

The upper flange 20 is formed to extend in the front-rear direction D. The top plate 19 and the upper flange 20 are arranged at intervals in the up-down direction H. The upper flange 20 has a first upper flange 20A and a second upper flange 20B. The first upper flange 20A and the second upper flange 20B are arranged with the stack 9 interposed therebetween and spaced apart from each other in the front-rear direction D.

The hanging wall 21 connects the top plate 19 and the upper flange 20. More specifically, the hanging wall 21 has a first hanging wall 21A and a second hanging wall 21B. The first hanging wall 21A and the second hanging wall 21B are arranged in the front-rear direction D. The first hanging wall 21A connects one end of the top plate 19, which is arranged in the front-rear direction D, to an end portion of the first upper flange 20A. The second hanging wall 21B connects the other end of the top plate 19, which is arranged in the front-rear direction D, to the end of the second upper flange 20B.

The lower case 17 is formed so as to open upward. The lower case 17 is formed of a bottom plate 22, a lower flange 23, and an upright wall 24.

The bottom plate 22 is located on the lower surface of the case of the housing case 11. The bottom plate 22 is a plate-shaped member. The bottom plate 22 is formed in a shape having the same outer shape as that of the top plate 19 when the bottom plate 22 is viewed from a position separated from the bottom plate 22 in the up-down direction H in plan view. The bottom plate 22 is disposed with the stack 9 interposed therebetween and spaced apart from the top plate 19 in the up-down direction H.

The lower flange 23 is formed to extend in the front-rear direction D. The bottom plate 22 and the lower flange 23 are arranged at intervals in the up-down direction H. The lower flange 23 has a first lower flange 23A and a second lower flange 23B. The first lower flange 23A and the second lower flange 23B are arranged with the stack 9 interposed therebetween and spaced apart from each other in the front-rear direction D.

The first lower flange 23A is fixed to the underbody 4 shown in FIG. 1 together with the first upper flange 20A. The second lower flange 23B is fixed to the underbody 4 shown in FIG. 1 together with the second upper flange 20B. Thus, the power storage device 3 is fixed to the vehicle body 2.

The upright wall 24 connects the bottom plate 22 and the lower flange 23. More specifically, the upright wall 24 has a first upright wall 24A and a second upright wall 24B. The first upright wall 24A and the second upright wall 24B are arranged in the front-rear direction D. The first upright-wall 24A connects one end of the bottom plate 22, which is arranged in the front-rear direction D, to an end portion of the first lower flange 23A. The second upright-wall 24B connects the other end of the bottom plate 22, which is arranged in the front-rear direction D, to the end of the second lower flange 23B.

The share panel 5 is disposed below the lower case 17 of the power storage device 3 in the up-down direction H. The share panel 5 is formed so as to open upward. A buffer space R3 is formed between the share panel 5 and the lower case 17. The share panel 5 includes a main body portion 29 and a pair of connecting portions 30.

The pair of connecting portions 30 are arranged so as to be spaced apart from each other in the front-rear direction D. One end of each of the pair of connecting portions 30 is connected by a main body portion 29. Each of the other ends of the pair of connecting portions 30 is joined to the underbody 4.

The buffer space R3 is located between the first and second reinforcements 31 and 32.

The first reinforcement 31 is disposed in the buffer space R3 and is fixed to the lower surface 17A of the lower case 17. A plurality of first reinforcements 31 are arranged at intervals in the front-rear direction D. The first reinforcement 31 includes a pair of joining portions 33, a main body portion 34, and a connecting portion 35. The joining portions 33 are arranged at intervals in the front-rear direction D. The main body portion 34 is disposed between the pair of joining portions 33 and below the pair of joining portions 33. The connecting portion 35 connects each of the end portions of the pair of joining portions 33 and each of the outer peripheral end portions arranged in the front-rear direction D of the main body portion 34. The main body portion 34 and the connecting portion 35 are formed so as to protrude downward with respect to the joining portion 33. The first reinforcement 31 is fixed to the lower case 17 by fixing the joining portion 33 to the lower surface 17A of the lower case 17.

The second reinforcement 32 is disposed in the buffer space R3 and is fixed to the upper surface 5A of the share panel 5. A plurality of second reinforcements 32 are arranged at intervals in the front-rear direction D. The second reinforcement 32 includes a pair of joining portions 36, a main body portion 37, and a connecting portion 38. The joining portions 36 are arranged at intervals in the front-rear direction D. The main body portion 37 is disposed between the pair of joining portions 36 and above the pair of joining portions 36. The connecting portion 38 connects each of the end portions of the pair of joining portions 36 and each of the outer peripheral end portions arranged in the front-rear direction D of the main body portion 34. The main body portion 37 and the connecting portion 38 are formed so as to protrude upward with respect to the joining portion 36. The second reinforcement 32 is fixed to the share panel 5 by fixing the joining portion 36 to the upper surface 5A of the share panel 5.

Note that each of the plurality of second reinforcements 32 disposed in the buffer space R3 is disposed between the first reinforcements 31. As a result, in the buffer space R3, the first reinforcement 31 and the second reinforcement 32 are arranged alternately in the front-rear direction D.

In the power storage device 3 according to the above-described embodiment, the stack 9 and the top plate 19 are arranged at a gap G1 in the up-down direction H. For example, the vehicle member 80 illustrated in FIG. 2 is fixed to the seat cross 7A, 7B. The vehicle member 80 is, for example, a seat rail or a center console. The gap G1 is partially filled with an adhesive A1.

By adopting such a configuration, it is possible to suppress deformation of the top plate 19 caused by the expansion of the stack 9 in the up-down direction H as compared with the case where there is no gap G1. As a result, it is possible to suppress a load in the up-down direction H from being applied to the stack 9 from the top plate 19 due to expansion of the stack 9. Further, along with the expansion of the stack 9, it is possible to suppress the deformation of the peripheral components of the stack 9, for example, the seat-cross 7A, 7B and the vehicle member 80.

The stack 9 in the above-described embodiment is bonded to the top plate 19 of the upper cover 16 by an adhesive A1. With such a configuration, it is possible to suppress vibration of the stack 9 in the housing case 11.

In addition, the impact received by the power storage device 3 from the vehicle surroundings is transmitted to the stack 9. By transmitting the impact transmitted to the stack 9 to the upper cover 16 via the adhesive A1, it is possible to suppress the stack 9 from being damaged.

In the above embodiment, the top plate 19 is fixed to the floor panel 8 and the seat cross 7 by the fastening member 41. The stack 9 is bonded to the top plate 19 by an adhesive A1.

With such a configuration, the impact transmitted to the stack 9 can be transmitted to the upper cover 16, the floor panel 8, and the seat cross 7 via the adhesive A1. As a result, damage to the stack 9 due to impact from the surroundings can be suppressed.

The adhesive A1 in the above-described embodiment is applied to an area 40B of the top plate 19 excluding the area 40A corresponding to the seat cross 7 in the up-down direction H. The stack 9 is bonded to the top plate 19 by an adhesive A1 applied so as to fill the gap G1.

With such a configuration, when the stack 9 expands in the up-down direction H, it is possible to suppress the reaction force from the floor panel 8, the seat cross 7, and the fastening member 41 received by the stack 9.

More specifically, when the stack 9 expands, the adhesive A1 applies a reaction force to the stack 9. When the adhesive A1 is applied to the area 40A and the area 40B, the adhesive A1 transmits the reaction force from the top plate 19 to the stack 9 in the area 40B. In the area 70A, the adhesive A1 transmits the reaction force from the seat cross 7, the floor panel 8, the top plate 19, and the fastening member 41 to the stack 9.

By setting the application area of the adhesive A1 to the area 40B only, the space R2 is maintained between the top plate 19 and the stack 9 below the seat cross 7. As a result, the reaction force from the seat cross 7, the floor panel 8, and the fastening member 41 received by the stack 9 can be suppressed. Further, deformation of the seat cross 7 due to expansion of the stack 9 can be suppressed.

The top plate 19 in the above-described embodiment is disposed below the floor panel 8 with a gap G2 between the floor panel 8 and the up-down direction H.

With such a configuration, even in a case where the stack 9 undergoes expansion accompanied by deformation of the top plate 19, the reaction force that the stack 9 receives from the seat cross 7 or the floor panel 8 can be suppressed until the top plate 19 comes into contact with the floor panel 8.

Similarly, even in a case where the stack 9 is expanded with deformation of the top plate 19, no load is applied to the floor panel 8 through the top plate 19 until the top plate 19 comes into contact with the floor panel 8. Therefore, deformation of the seat cross 7 and the floor panel 8 can be suppressed.

In the vehicle 1 according to the above-described embodiment, the seat cross 7, the floor panel 8, and the top plate 19 are fixed in the up-down direction H by the fastening member 41. The gap G1 between the top plate 19 and the stack 9 is formed to be wider than the gap G2 between the top plate 19 and the floor panel 8. The stack 9 and the top plate 19 are bonded to each other by an adhesive A1 applied to the area 40B. A space R2 is formed in a gap G1 between the top plate 19 and the stack 9.

With such a configuration, the stack 9 expands in the up-down direction H, and the adhesive A1 applied to the area 40B deforms the top plate 19 upward. Thus, on the lower surface 19B of the top plate 19, the area 40B is deformed to be closer to the upper surface 13 of the stack 9 than the area 40A. Here, since the gap G1 is larger than the gap G2, the upper surface 19A of the top plate 19 reaches the floor panel 8 prior to the lower surface 19B of the area 40A reaching the upper surface 13 of the stack 9. Accordingly, it is possible to suppress the gap between the lower surface 19B of the area 40A and the upper surface 13 of the stack 9 from approaching after the upper surface 19A of the top plate 19 reaches the floor panel 8. As a result, the lower surface 19B of the top plate 19 in the area 40A reaches the upper surface 13 of the stack 9, and it is possible to suppress a local load from being applied to the stack 9.

The adhesive A1 in the above-described embodiment is applied to the area 40B so as to fill the space between the upper surface 13 of the stack 9 and the lower surface 19B of the top plate 19, but the present disclosure is not limited thereto. Instead of the adhesive A1, for example, an elastic material may be arranged. The elastic body adheres the stack 9 to the top plate 19. Specifically, the elastic body is formed to have a thickness corresponding to the gap G1, and an adhesive layer is formed on a surface of the elastic body corresponding to the upper surface 13 or the lower surface 19B in the up-down direction H.

By adopting such a configuration, it is possible to suppress the use of the adhesive A1 as compared with when the adhesive A1 is applied between the stack 9 and the top plate 19.

### MODIFICATION

In the above-described embodiment, the stack 9 is bonded to the top plate 19 forming the upper cover 16, but the present disclosure is not limited thereto. For example, the floor panel 8 may form part of the upper cover 16, and the stack 9 may be bonded to the floor panel 8. Details are shown below.

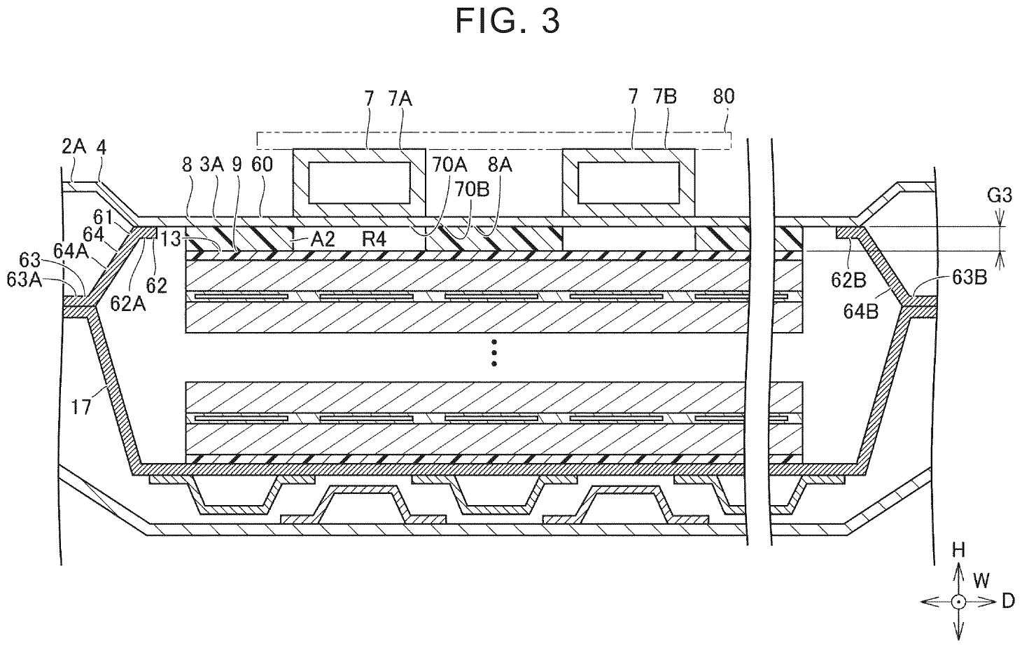

FIG. 3 is a cross-sectional view of a vehicle body and a power storage device according to a modification of the present embodiment. The vehicle body 2A and the power storage device 3A according to the modification have the same configuration as the vehicle body 2 and the power storage device 3 according to the embodiment of the present disclosure unless otherwise described below.

The power storage device 3A includes a housing case 60 and a stack 9. The housing case 60 houses the stack 9. The housing case 60 includes an upper cover 61 and a lower case 17.

The upper cover 61 is formed of a part of the floor panel 8, a fixing member 62, an upper flange 63, and a hanging wall 64. Note that the floor panel 8 in the modified example is an example of a “plate member” of the present disclosure.

The floor panel 8 is formed so as to cover the upper surface 13 of the stack 9. The upper cover 61 is located on the upper surface of the housing case 60. The floor panel 8 and the stack 9 are arranged with a gap G3 therebetween in the up-down direction H. The stack 9 is disposed below the floor panel 8.

The stack 9 is bonded to the floor panel 8. Specifically, the upper surface 13 of the stack 9 is bonded to the lower surface 8A of the floor panel 8 by an adhesive A2. The adhesive A2 is applied to the area 70B of the lower surface 8A of the floor panel 8 except for the area 70A corresponding to the seat cross 7 in the up-down direction H. The space R4 is defined by the adhesive A2 applied to the area 70B, the top plate 19, and the stack 9.

The fixing member 62 is formed to extend in the front-rear direction D. The fixing member 62 is provided on the lower surface 8A of the floor panel 8. The fixing member 62 is joined to the floor panel 8 in a region of the floor panel 8 corresponding to the fixing member 62 in the up-down direction H. The fixing member 62 includes a first fixing member 62A and a second fixing member 62B. The first fixing member 62A and the second fixing member 62B are arranged so as to be spaced apart from each other with the stack 9 interposed therebetween in the front-rear direction D.

The upper flange 63 is formed to extend in the front-rear direction D. The top plate 19 and the upper flange 63 are arranged at intervals in the up-down direction H. The upper flange 63 has a first upper flange 63A and a second upper flange 63B. The first upper flange 63A and the second upper flange 63B are arranged with the stack 9 interposed therebetween and spaced apart from each other in the front-rear direction D.

The hanging wall 64 connects the fixing member 62 and the upper flange 20. More specifically, the hanging wall 64 has a first hanging wall 64A and a second hanging wall 64B. The first hanging wall 64A and the second hanging wall 64B are arranged in the front-rear direction D. The first hanging wall 64A connects an end portion of the first fixing member 62A and an end portion of the first upper flange 63A. The second hanging wall 64B connects an end portion of the second fixing member 62B and an end portion of the second upper flange 63B.

In the upper cover 61 of the above-described embodiment, the floor panel 8 is one of the constituent elements. The stack 9 and the floor panel 8 are arranged at a gap G3 in the up-down direction H.

By adopting such a configuration, it is possible to suppress the deformation of the floor panel 8 caused by the expansion of the stack 9 in the up-down direction H as compared with the case where there is no gap G3. As a result, it is possible to suppress a load in the up-down direction H from being applied from the floor panel 8 to the stack 9 by expansion of the stack 9. In addition, it is possible to suppress deformation of peripheral components of the stack 9, for example, the vehicle member 80, due to expansion of the stack 9.

The stack 9 in the above-described embodiment is bonded to the floor panel 8 by an adhesive A2. With such a configuration, it is possible to suppress vibration of the stack 9 in the housing case 60. The impact received by the power storage device 3A from the surroundings of the vehicles is transmitted to the stack 9. The impact transmitted to the stack 9 is transmitted to the floor panel 8 via the adhesive A2, whereby the stack 9 can be suppressed from being damaged.

The adhesive A2 in the above-described embodiment is applied to the area 70B of the floor panel 8 except for the area 70A corresponding to the seat cross 7 in the up-down direction H. The stack 9 is bonded to the floor panel 8 by an adhesive A2 applied so as to fill the gap G3.

By adopting such a configuration, it is possible to suppress the reaction force received from the adhesive A2 when the stack 9 expands in the up-down direction H.

More specifically, when the stack 9 expands, the adhesive A2 applies a reaction force to the stack 9. When the adhesive A2 is applied to the area 70A and the area 70B, the adhesive A2 transmits the reaction force transmitted from the floor panel 8 to the adhesive A2 to the stack 9 in the area 70B. In the area 70A, the adhesive A2 transmits the reaction force transmitted from the seat cross 7 and the floor panel 8 to the adhesive A2 to the stack 9.

By setting the application area of the adhesive A2 to the area 70B only, a space R4 is maintained between the floor panel 8 and the stack 9 below the seat cross 7. Accordingly, the reaction force transmitted from the seat cross 7 to the stack 9 via the adhesive A2 can be suppressed. That is, when the stack 9 expands in the up-down direction H, the reaction force that the stack 9 receives from the adhesive A2 can be suppressed. Further, deformation of the seat cross 7 due to expansion of the stack 9 can be suppressed.

The embodiment disclosed this time should be considered to be illustrative in all respects and not restrictive. The scope of the present disclosure is indicated by the claims rather than the description of the embodiment described above, and it is intended that all changes within the meaning and scope equivalent to the claims are included.

What is claimed is:

1. A power storage device that is installed in a vehicle, wherein:
the vehicle includes a support member that is situated upward from the power storage device;
the power storage device includes a stack that is made by stacking power storage modules in an up-down direction, and a housing case that houses the stack;
the housing case is fashioned so as to cover an upper face of the stack, and also includes a plate member that is situated on an upper face of the housing case, downward from the support member; and
the stack is bonded to the plate member in a region of the plate member excluding a region corresponding to the support member in the up-down direction.

2. The power storage device according to claim 1, wherein:
in the vehicle, a vehicle cabin space is fashioned in which a passenger rides; and
the vehicle cabin space and a vehicle outer space are partitioned by the plate member.

3. The power storage device according to claim 1, wherein:
the vehicle further includes a floor member;
the floor member is situated downward from the support member;
the housing case further includes an upper cover and a lower case; and
the upper cover includes the plate member.

4. The power storage device according to claim 3, wherein the floor member and the plate member are arrayed in the up-down direction with a spacing between.

5. The power storage device according to claim 4, wherein:
the support member, the floor member, and the plate member are fixed in the up-down direction by a linking member; and
a spacing in the up-down direction between the plate member and the stack is greater than the spacing in the up-down direction between the floor member and the plate member.
